(19) United States
(12) Patent Application Publication
(10) Pub. No.: US 2026/0232002 A1
(43) Pub. Date: Aug. 13, 2026

(54) METHOD AND APPARATUS FOR INTEGRATED ASSISTED PREPARATION OF ANIMAL FOOD

(71) Applicant: Matthew J. Terrill, Hermosa Beach, CA (US)

(72) Inventor: Matthew J. Terrill, Hermosa Beach, CA (US)

(21) Appl. No.: 19/151,273

(22) PCT Filed: Feb. 2, 2024
(86) PCT No.: PCT/US24/14261

§ 371 Date: Jul. 25, 2025

Related U.S. Application Data
(60) Provisional application No. 63/482,925, filed on Feb. 2, 2023.

(51) Int. Cl. A23N 17/00; A23K 40/00

(52) U.S. Cl. CPC A23N 17/004; A23K 40/00; A23N 17/007

(57) ABSTRACT

A method and apparatus for automatic processing of animal food is disclosed. In one embodiment, the method comprises (a) accepting, in a recipe processor communicatively coupled to the ingredient processor, pet information, the pet information determining nutritional requirements of the pet; (b) accepting, in the recipe processor, a selection of a dish and a batch size; (c) determining, in the recipe processor, the recipe from the pet information, the dish, and the batch size, the recipe comprising a plurality of ingredients, each of the plurality of ingredients associated with an ingredient amount, and an ordered set of food processor instructions for preparing the animal food dish; and (d) accepting ingredients in the ingredient processor and automatically processing the ingredients according to the recipe.

### CROSS-REFERENCE TO RELATED APPLICATIONS

This application claims benefit of U.S. Provisional Patent Application No. 63/482,925, entitled “METHOD AND APPARATUS FOR INTEGRATED ASSISTED PREPARATION OF ANIMAL FOOD,” by Matthew J. Terrill, filed Feb. 2, 2023, which application is hereby incorporated by reference herein.

### BACKGROUND

### 1. Field

The present disclosure relates to systems and methods for preparing animal food.

### 2. Description of the Related Art

It is known that diet is an important factor in the health and well-being of animals, including pets. Unfortunately, commercially available pet food is typically overpriced, and can cause significant difficulties, including partial digestion, skin allergies, loose stools that are difficult to manage. There is the option of preparing pet food by hand at the home, but such preparation can take hours and turn the kitchen into a cluttered mess. Such preparation also typically requires constant mixing by hand. Further, even homemade pet food has significant disadvantages. First, it is difficult to design meals for particular pets that precisely meet the pet's caloric and nutritional needs, and as a result, many pets have diets with caloric deficiencies or excesses, and nutritional deficiencies. Further exacerbating the problem scaling pet food recipes for pets that are different sizes, activeness, or breed, or for different feeding schedules. The result is a great deal of waste, or worse yet, owners who fail to feed their pet a balanced diet designed for the pet.

What is needed is a method and apparatus that assists in the preparation of pet food that meets each individual pet's needs.

### SUMMARY

To address the requirements described above, this document discloses a system and method for preparing animal food.

In one embodiment, the method comprises (a) accepting, in a recipe processor communicatively coupled to the ingredient processor, pet information, the pet information determining nutritional requirements of the pet; (b) accepting, in the recipe processor, one or more user-identified ingredients selected from an ingredient database, the ingredient database storing nutritional information regarding each ingredient in the ingredient database; (c) computing, in the recipe processor, a recipe nutritional value from nutritional information of the selected ingredient; (d) comparing the computed recipe nutritional value to the determined nutritional requirements of the pet to determine if the recipe nutritional value meets the determined nutritional requirements of the pet;
(e) if the recipe nutritional value does not meet the nutritional requirements of the pet, repeating steps (b)-(d) removing user-identified ingredients or accepting further user identified ingredients selected from the ingredient database, recomputing the recipe nutritional value from the nutritional information of the further user-identified ingredients, and comparing the computed recipe nutritional value to the determined nutritional requirements of the pet; and(f) if the recipe nutritional value meets the nutritional requirements of the pet, transmitting, from the recipe processor to the ingredient processor, processing commands to prepare the animal food according to the recipe.

Another embodiment is evidenced by an apparatus having a processor and a communicatively coupled memory storing processor instructions for performing the foregoing operations.

In another embodiment, the method comprises (a) accepting, in a recipe processor communicatively coupled to the ingredient processor, pet information, the pet information determining nutritional requirements of the pet; (b) accepting, in the recipe processor, a selection of a dish and a batch size; (c) determining, in the recipe processor, the recipe from the pet information, the dish, and the batch size, the recipe comprising a plurality of ingredients, each of the plurality of ingredients associated with an ingredient amount, and an ordered set of food processor instructions for preparing the animal food dish; and (d) accepting ingredients in the ingredient processor and automatically processing the ingredients according to the recipe. Another embodiment is evidenced by an apparatus having a processor and a communicatively coupled memory storing processor instructions for performing these operations.

Still another embodiment is evidenced by an apparatus for preparing animal food. The apparatus comprises an ingredient processor and a recipe processor. The ingredient processor comprises a vessel for holding a plurality of ingredients; blades disposed in the vessel, the blades coupled to a motor for rotating the blades; and a heater, thermally coupled to the vessel for heating the ingredients. The recipe processor is communicatively coupled to the ingredient processor, and has a digital processor communicatively coupled to a memory storing digital processor instructions comprising digital processing instructions for: generating or retrieving a recipe using at least a subset of the ingredients; generating ingredient processor commands to prepare the animal food according to the recipe, the ingredient processor commands comprising: heater commands, for heating one or more of the ingredients according to the recipe; motor commands, for blending one or more of the ingredients according to the recipe; wherein the recipe processor is communicatively coupled to: an ingredient database storing nutritional information regarding each ingredient in the ingredient database; a recipe database storing one or more recipes, each recipe comprising a combination of ingredients and a procedure to combine the ingredients; and an animal database, storing information regarding at least one animal, the information determining nutritional requirements of the animal.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIGS. 1A and 1B are diagrams illustrating one embodiment of the food processor;

FIG. 2 is a diagram illustrating exemplary operations that can be employed to process animal food;

FIG. 3 is a diagram illustrating further exemplary operations that can be employed to process animal food;

FIG. 4 is a diagram illustrating operations associated with the main menu presented by the recipe processor;

FIG. 5 is a diagram illustrating operations associated with the home menu;

FIG. 6A is a diagram illustrating operations associated with the administrator's home screen;

FIG. 6B is a diagram illustrating operations associated with managing all recipes;

FIG. 6C is a diagram illustrating operations associated with approving community inspired recipes;

FIG. 6D is a diagram illustrating exemplary operations associated with managing users;

FIG. 6E is a diagram illustrating exemplary operations associated with adding ingredients to the ingredient database;

FIG. 6F is a diagram illustrating exemplary operations associated with selecting the activity level of an animal in the animal database;

FIG. 6G is a diagram illustrating exemplary operations associated with entering deviations ranges for the nutrients;

FIG. 7 is a diagram illustrating exemplary operations associated with adding an animal profile having animal data into the animal database;

FIG. 8A is a diagram illustrating an exemplary embodiment of operations for managing recipes;

FIG. 8B is a diagram illustrating an exemplary embodiment of operations for managing suggested recipes;

FIG. 8C is a diagram illustrating an exemplary embodiment of operations for accessing and managing recipes shared by others;

FIGS. 8D and 8E are diagrams illustrating exemplary embodiments of operations for customized recipes and veterinarian formulated recipes;

FIG. 8G is a diagram illustrating exemplary embodiments of operations to manage shared recipes;

FIG. 8H is a diagram illustrating exemplary embodiments of operations to view and manage recipes;

FIG. 8I is a diagram illustrating exemplary embodiments of operations to edit a recipe;

FIG. 8J is a diagram illustrating operations performed when the grocery list is selected;

FIG. 8K is a diagram illustrating the operations performed when the cook now option is selected;

FIG. 8L is a diagram illustrating the calculation of nutrients in a batch;

FIG. 8M is a diagram illustrating the nutrition calculation;

FIG. 9 is a diagram illustrating exemplary embodiments of operations to make a batch of food;

FIG. 10 is a diagram illustrating exemplary embodiments of operations to add a meal plan;

FIG. 11 is a diagram illustrating exemplary operations related to accessing an ecommerce platform;

FIG. 12 is diagram of the nutritional profile of a dietary supplement for dogs;

FIG. 13 is a diagram illustrating an exemplary computer system that could be used to implement processing elements of the geolocation system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

Described herein is a specialized apparatus that works with recipe-generating and nutritional-calculating software, allowing pet owners to make homemade pet food efficiently, while saving time and money while ensuring maximum nutrition. The apparatus generates a customized recipe based on the nutritional needs of each specific pet, then prepares the food to be ready to serve.

Conventional alternatives include low quality pet food ($1-$2 per pound), high quality pet food ($10/pound), or customizable store-bought fresh dog food ($20/pound and either under or overcooked and over processed to a textureless paste. Another conventional alternative is homemade pet food, but such food has unknown nutritional value, requires many pieces of cookware and appliances, demands hours of preparation, cooking, and cleanup time, constant manual mixing and stirring using underpowered automatic mixers or mixers without heating.

Advantages of the apparatus and method described below include the following: There is no need to consider or adjust for atwater factors. The system generates recipes and calculates nutritional factors, but the user is in full control of how the food is prepared and what is included in it. Since there are different schools of thought regarding the proper dietary recommendations per kg of body weight and acceptable deviation ranges, the system described below allows advanced users to adjust/define those values on their own (since new studies and other new information constantly emerge to support changes in the values and ranges, the default values are now and will always be constantly evolving). Further, the notion of “food groups” need not be used, and the user is not required to build a recipe by selecting a predetermined number of foods from each food group.

The system allows for alternating recipes to balance the pet's diet without need for supplements yet allows supplements to be included. The system allows for alternating recipes to balance the pet's diet with the specific goal of minimizing the amount of and cost of supplements while simultaneously allowing any supplement to be included provided the input of nutritional data per 100 grams of supplement.

The system supports using a social network of people sharing homemade pet food recipes and nutritional trends. Thus, community input is available for ingredients, ingredient amounts and values. Such information is also peer reviewed by the community of the social network.

The system can use goods and ingredients selected from the U.S. Department of Agriculture database of ingredients, but also supports user entered ingredients (with associated values).

The system lets users adjust values at each step of preparation, and is based on the batch size.

The system permits combining different recipes. This allows the user to plan meals for the pet, with each meal having different ingredients. The system aggregates the amount of each ingredient needed for all of the recipes, allowing the user to easily determine how much of each ingredient to purchase to allow production of selected numbers of batches of each of the recipes.

The system includes automatic mixing blades strong enough for the toughest ingredients. The design of the mixing blades, RPM, torque, spinning direction and duration, and cooking temperature are critical to proper pet food preparation and nutrition, and based on the recipe, are automatically set proper values to assure such proper preparation.

The foregoing features allow pet owners to make the highest quality food at home, and lower the cost of such pet food to about $1 a pound. It provides pet owners with the ability to adjust recipes to account for changing food costs, thus continually minimizing cost. It calculates nutritional values of the recipe being prepared and compares those nutritional values to the nutritional needs of the pet, accounting for the pet's type (e.g. dog, cat), breed (e.g. Australian Shepherd or Chihuahua), activity level, and weight. The system allows the preparation of homemade dog food with only one kitchen appliance, in about half the time as conventional methods. The system permits evenly and precisely cooked food to be prepared, thus preventing undercooked or overcooked food. Since undercooked or overcooked food are less digestible and less nutrients are absorbed by the pet, this saves money.

### Food Processor

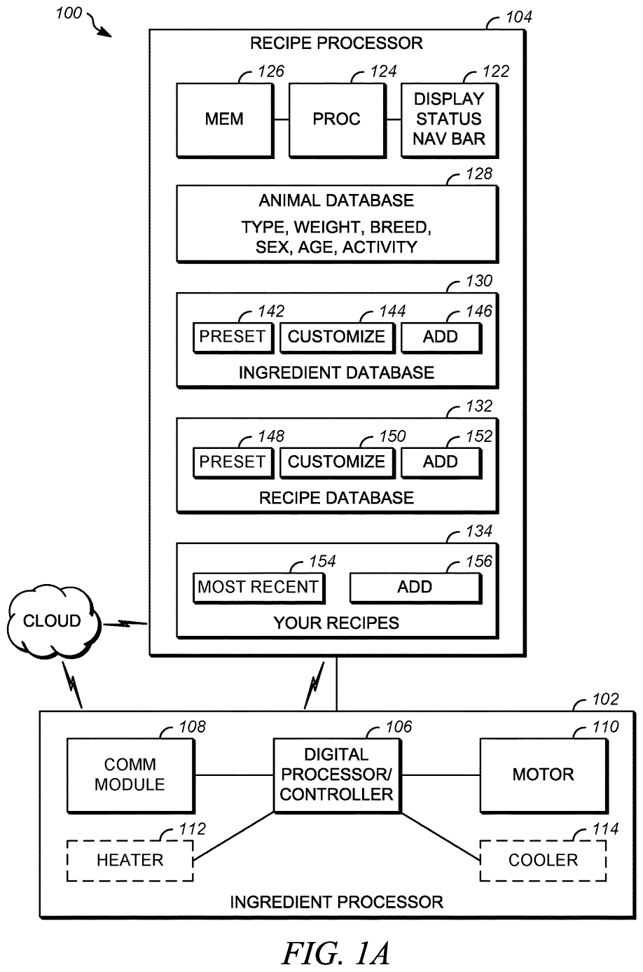

FIGS. 1A and 1B are diagrams illustrating one embodiment of the food processor 100. The food processor comprises an ingredient processor 102 communicatively coupled to a recipe processor 104. The ingredient processor 102 comprises a vessel 162 for holding a plurality of ingredients, blades 164 disposed in the vessel 162, and an optional heater 112 thermally coupled to the vessel 162 for heating the ingredients. The vessel 612 includes a lid 163. The lid may include adjustable clamps designed to affix the lid 163 to the vessel 612, particularly when the lid is designed to be able to retrofit old slow cookers and pressure cookers. An optional cooler 114 may also be provided for refrigerating the food during or after processing. The cooler 114 may comprise thermoelectric plates or surfaces on or within a wall of the vessel 162, the thermoelectric plates controlled by the recipe processor according to cooling digital processor instructions to cool the plurality of ingredients. In another embodiment, the cooler 114 comprises a cavity within the wall of the vessel 114 (in one embodiment, circumferentially surrounding the ingredients), for cooling the ingredients via a circulation of a liquid though the cavity. The blades 164 are rotated by a motor 110 within housing 172, but may also be powered by a hand wound mechanical spring.

The housing 172 and the vessel 162 are communicatively coupled via coupling 162, which provides the require mechanical and electrical connections between the vessel 162 and the housing 172, in particular, the mechanical coupling between the motor 110 and the blades 164 and the electrical connection between the digital processor/controller 106 and the heater 112 and cooler 114.

The food processor 100 also comprises a recipe processor 104 communicatively coupled to the ingredient processor 102. The recipe processor may be disposed in the housing 172 or may instead be implemented by separate computing device such as a smartphone 178 in wireless communication with the ingredient processor 102. The recipe processor 104 generates or retrieves a stored recipe that uses at least a subset of the ingredients and generates ingredient processor commands to prepare the animal food according to the recipe.

In one embodiment, the recipe processor 104 includes a digital processor 124 communicatively coupled to a memory 126 storing digital processor instructions. The digital processor instructions include heater commands, for heating one or more of the ingredients according to the recipe, and motor commands, for blending one or more of the ingredients according to the recipe.

In one embodiment, the memory 126 stores a pet database 120, an ingredient database 130, and a recipe database 132. Optionally, the memory 126 also stores saved recipes 134 personal to the user In another embodiment, the ingredient database 130, the recipe database 132, the pet database 128, and the optional saved recipes 134 are stored in a storage location remote from, but communicatively coupled to the recipe processor 104.

The ingredient database 130 stores nutritional information regarding each ingredient included in the ingredient database. This information can be retrieved from the United States Department of Agriculture (USDA) database, Association of American Food Control Officials (AAFCO), National Research Council (NRC) or another standard determined by the user. Such standard databases can be accessed by the user via the preset control 142. The user may also add ingredients to the database via the add control 146 and customize ingredients already in the database (e.g. to change amounts or calorie content) via the customize control 150. A list of such ingredients and information regarding each ingredient may be recalled and provided for visual inspection by the display 122.

The recipe database 132 stores one or more recipes, each recipe comprising a combination of ingredients and a procedure to combine the ingredients. For example, the recipe may call for adding an amount (e.g. weight, volume, or other measure) of ingredients 1 and 2 to the vessel, then activating the motor to drive blades at a certain RPM for a particular length of time and under a particular heat. The recipe database 132 includes recipes available from external sources, including social media. A list of the recipes and information regarding each recipe may be recalled and provided for visual inspection by the display 122.

The animal database 128 stores information regarding one or more animals, and can include, for example, the animal's weight, type, breed, sex, age, activity and any other metric relevant to the animal's nutrition needs.

The user may also create and store their own recipes in the user recipe database 134.

### Process Overview

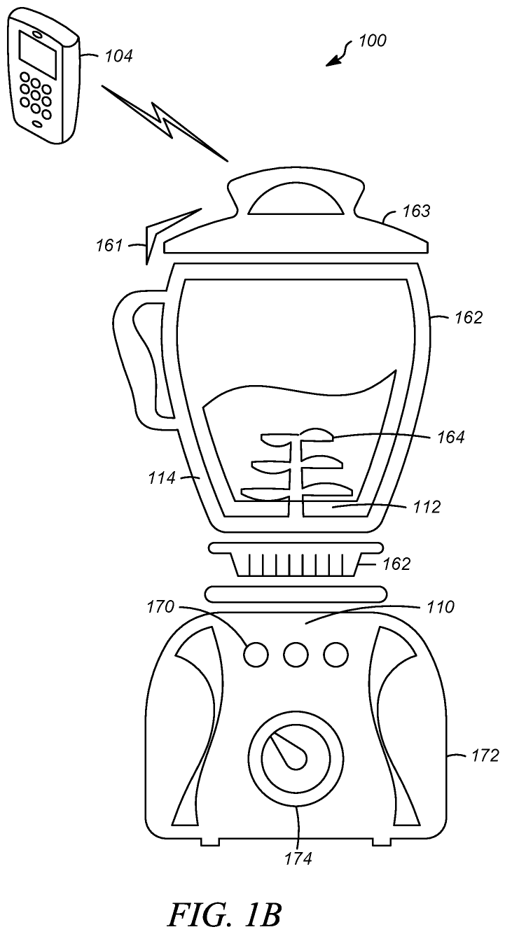

FIG. 2 is a diagram illustrating exemplary operations that can be employed to process animal food. In this embodiment, the user selects from a list of available recipes to generate the animal food.

In block 202, the recipe processor 104 accepts animal information that is sufficient to determine the nutritional requirements of the pet. Such information may include the animal's type (e.g. cat, dog or horse), the animal's weight, the animal's breed (e.g. collie or retriever), the animal's sex, the animal's age, and the animal's activity level. In one embodiment, the user may enter the target caloric and nutritional information directly, for example if the user wants to put the animal on a reduced or increased calorie diet, while maintaining necessary nutrition. This information is received and entered into the animal database 128. In block 204, a selection of a dish and batch size is accepted in the recipe processor 104. The dish (e.g. beef and potato dinner) is selected from the recipe database 132. In block 206, the recipe processor 104 determines an ordered set of food processor instructions for preparing the animal food dish. This is prepared from the animal information stored in the animal database, the dish stored in the recipe database 132, and the entered batch size. In block 212, the ingredient processor 102 accepts the ingredients and automatically processes the ingredients as they are accepted according to the recipe. Following preparation, the prepared food may be stored in special storage containers for the rapid and uniform cooling after cooking, freezing, and reheating of fresh pet food using microwave and freezer safe reusable containers with suitable dimensions. Such dimensions may include a height that is less than 2″ high, a shape that is round/shallow and cylindrical in overall shape, at least 2× as wide as tall. Further, such containers may have a lid that creates gaps when stacked, to facilitate even cooling and prevents hot spots when reheating.

FIG. 2 also illustrates an optional feature wherein the recipe processor 104 automatically generates a shopping list of the plurality of ingredients, each item on the shopping list also associated with an amount of the ingredient. That shopping list can also be automatically transmitted to an ingredient vendor such as a local market, for example, through a cellphone application sponsored by that local market, as shown in block 210.

In one embodiment, the food processor 100 can be used to compute nutritional value and cost for a plurality of recipes. For example, the user may select a second dish and a second batch size, and the food processor 100 will compute, from the second dish, the second batch size, and the animal information, a second recipe. In this case, the shopping list can be updated to reflect the second recipe as well as the first recipe. This can be repeated for several dishes, with the processor 100 generating a shopping list for the aggregate of all of the entered dishes. Similarly, the user may have several animals. Analogous operations can be used to enter the information for each of the animals, and different dishes and batch sizes for each animal. In this case, the food processor 100 can determine an aggregate shopping list for all of the entered animals and their dishes, so that a single unified shopping list for all animals is generated.

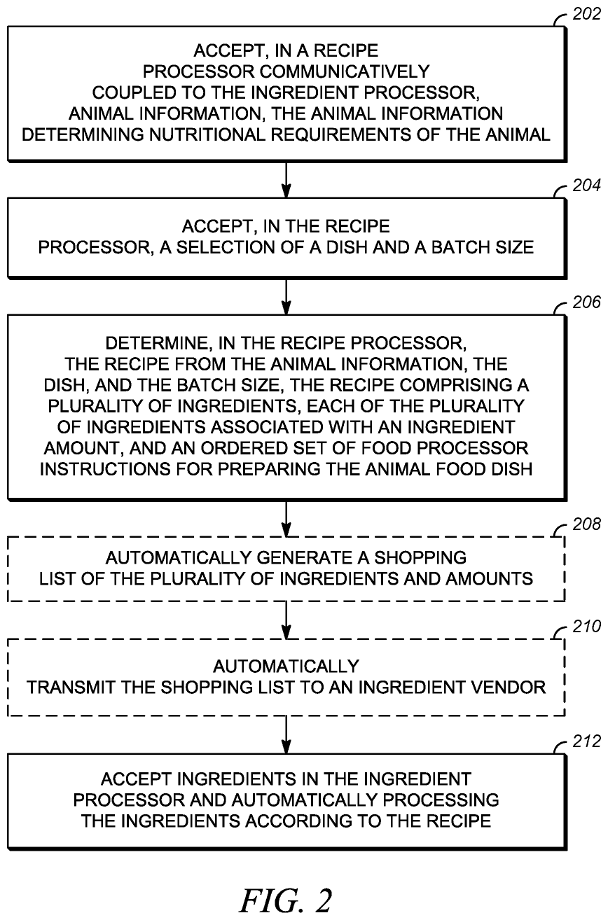

FIG. 3 is a diagram illustrating further exemplary operations that can be employed to process animal food. In this embodiment, the user generates a recipe by selecting ingredients and amounts of ingredients, as well as processing commands and procedural steps.

In block 302, animal information is accepted by the recipe processor 104. The animal information includes information sufficient to determine the nutritional requirements of the animal, including for example, the animal's type (e.g. cat, dog or horse), the animal's weight, the animal's breed (e.g. collie or retriever), the animal's sex, the animal's age, and the animal's activity level. In one embodiment, the user may enter the target caloric and nutritional information directly, for example if the user wants to put the animal on a reduced or increased calorie diet, while maintaining necessary nutrition.

In block 304, the user is presented with a list of ingredients retrieved from the ingredient database 130, and the user selects the ingredient and the amount of ingredient to include in the recipe.

In block 306, the recipe processor 104 computes the nutritional value of the recipe from the nutritional information of the selected ingredient and the amount of the ingredient. In block 308, the nutritional value of the recipe is compared to the determined nutritional requirements of the animal to determine if the recipe nutritional value meets the determined nutritional requirements of the animal. Block 312 routes processing to block 134 to accept further user-identified ingredients (or alterations in the amount of each ingredient) selected from the ingredient database 130 and thereafter route processing to block 306 if the nutritional value of the recipe does not meet the nutritional requirements of the animal. If the nutritional value of the recipe meets the nutritional requirements of the animal, block 312 routes processing to block 316, which transmits processing commands from the recipe processor 104 to the ingredient processor 102 to prepare the animal food according to the recipe. In a typical embodiment, the user is prompted to enter the ingredients in the order called for by the recipe, and the ingredient processor 102 processes the currently inserted ingredients as indicated by the recipe, including heating and cooling, as necessary.

In addition to computing the nutritional content of the recipe as shown in block 306, the recipe processor may also compute the cost to prepare the batch of the dish according to the recipe. In doing so, the recipe refers to the ingredient database 130, which includes the cost of each ingredient. Such costs can be entered into the ingredient database by the user or may be retrieved from online databases.

### Processing Details

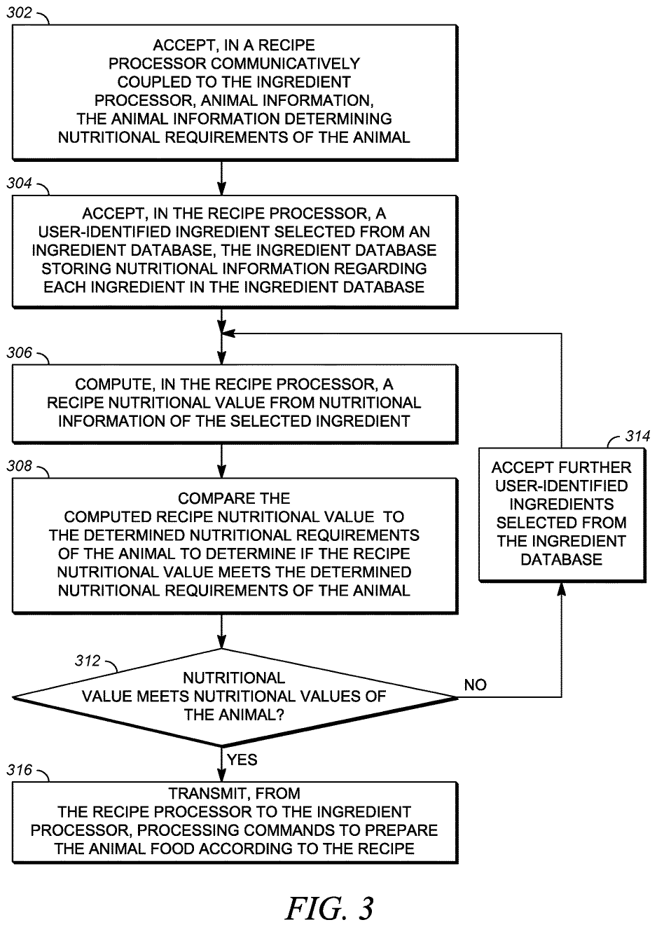

FIGS. 4-12 are diagrams presenting more detailed information regarding exemplary operations that can be employed to prepare animal food.

FIG. 4 is a diagram illustrating operations associated with the main menu presented by the recipe processor 104. The main menu 401 presents options to return to the home screen 402, go to administrator's home screen 404, go to a my pets interface 406 that lists the animals that have been entered into the animal database 128, go to recipes 408 that have been entered into the recipe database 132, go to a interface to make a batch of animal food 410, go to an advanced meal plan interface 412, go to an interface to shop for ingredients or recipes 416, logout 416, or close the application 418.

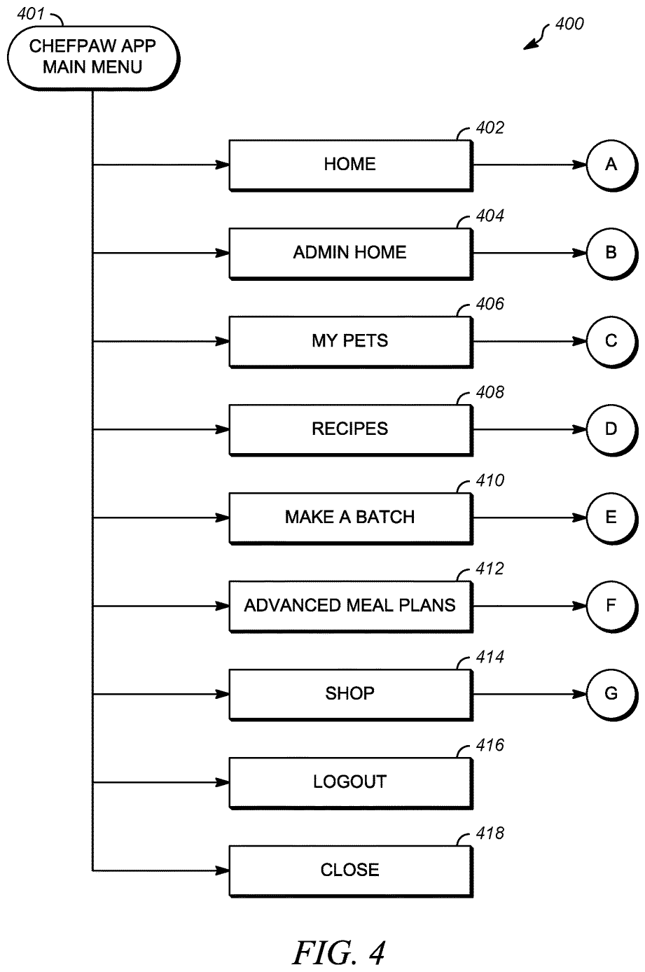

FIG. 5 is a diagram illustrating operations associated with the home menu. The home menu includes options to move to a pet profile interface 501, a recipe interface 502, an interface to make a batch of animal food 504, and an interface for advanced meal plans 506.

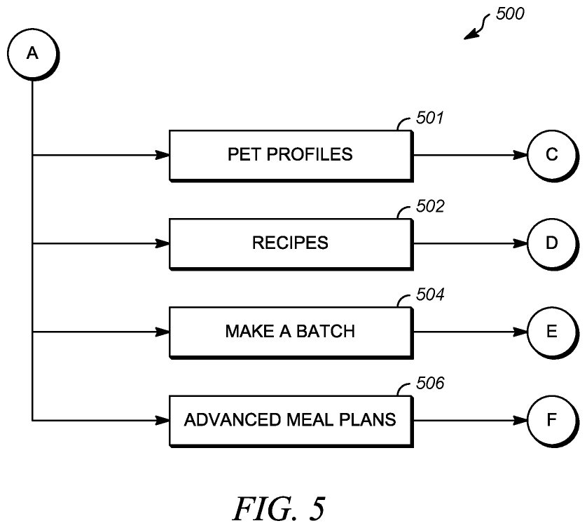

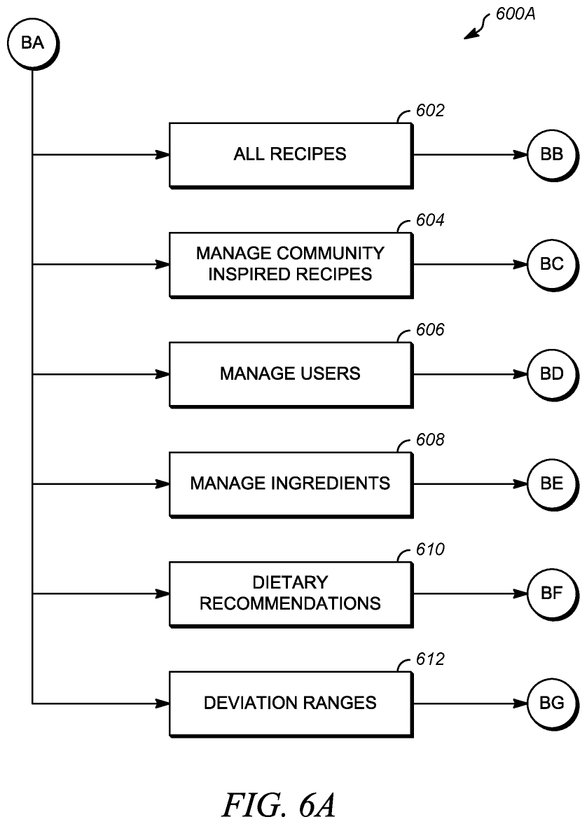

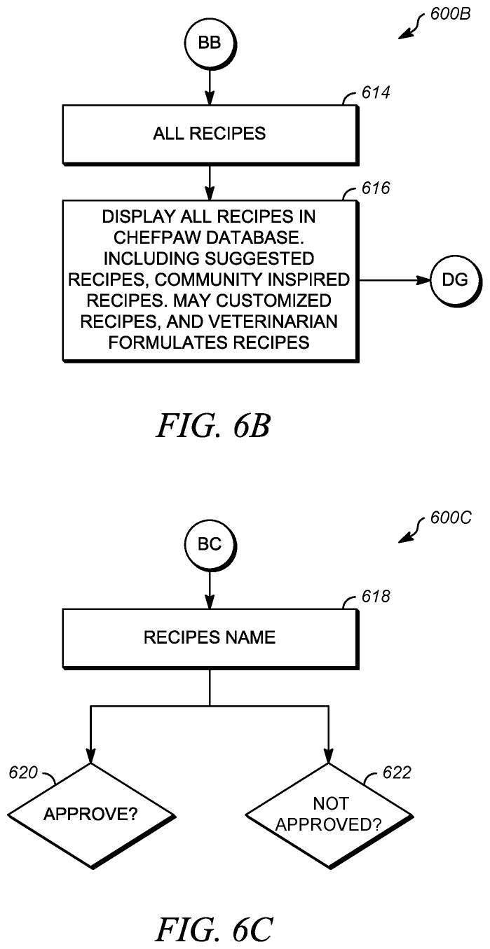

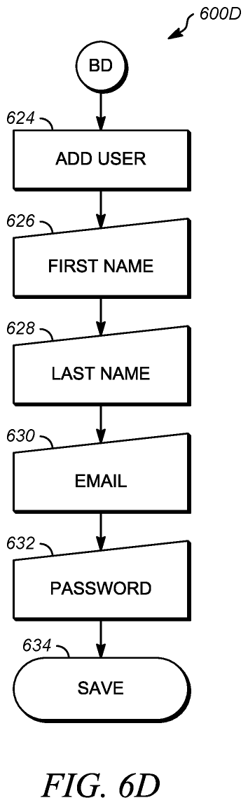

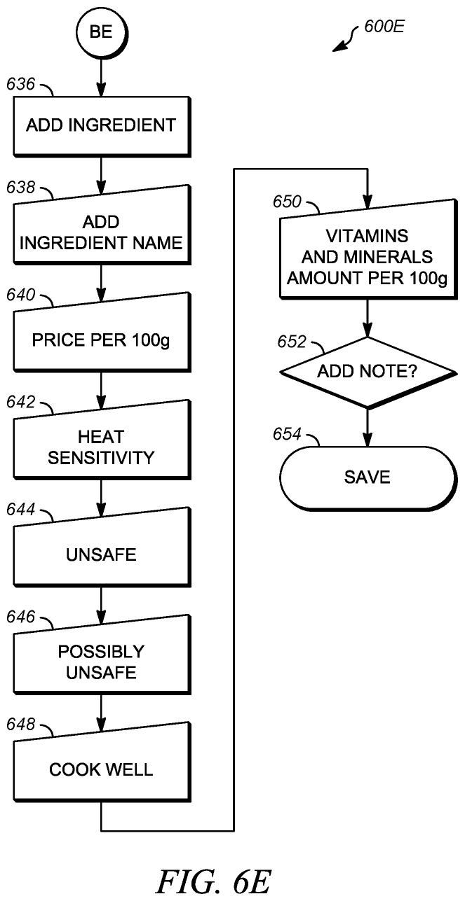

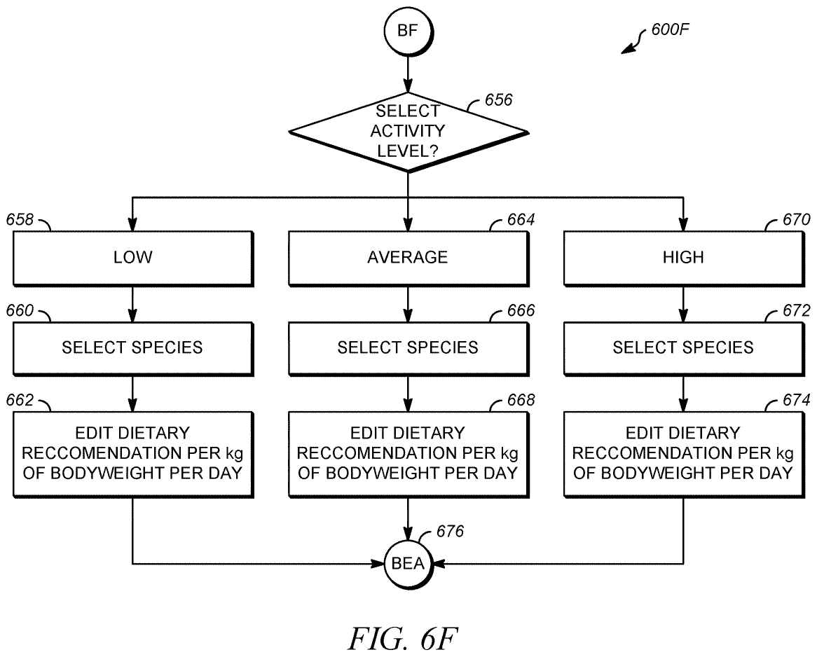

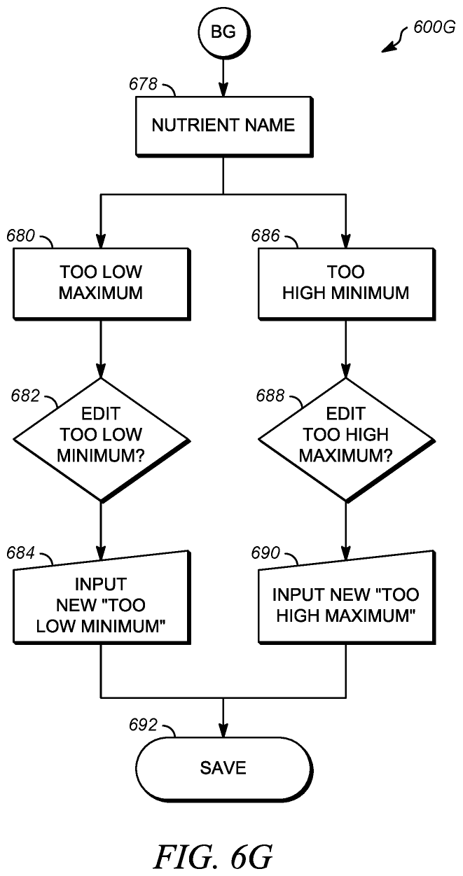

FIG. 6A is a diagram illustrating operations associated with the administrator's home screen. This interface presents options including options to view and manage all recipes 602, manage community inspired recipes (for example, those obtained from social media) 604, manage users 606, manage ingredients 608, manage dietary recommendations 610, and manage deviation ranges 612.

FIG. 6B is a diagram illustrating operations associated with managing all recipes. The interface presents an option to view and manage all recipes 614, and an option to access and approve community inspired recipes 616 (e.g. those from social media or other sources).

FIG. 6C is a diagram illustrating operations associated with approving community inspired recipes. A listing of community inspired recipes is presented. The user may select community inspired recipes for more information regarding such recipes, such as the recipe content, the originator, and optionally, reviews of the recipe from other individuals. The user may then select the recipe as shown in block 618 and either approve or not approve the recipe as shown in blocks 620 and 622, respectively.

FIG. 6D is a diagram illustrating exemplary operations associated with managing users 606. In the illustrated embodiment, a user is added by selecting an “add user” control as shown in block 624, then adding user information including the users first name, last name, and email, as shown in blocks 626-630, then entering a password for the user and saving the entry as shown in blocks 632 and 634.

FIG. 6F is a diagram illustrating exemplary operations associated with adding ingredients to the ingredient database 130. In block 636, the “add ingredient” control is selected. In blocks 638-652, the user uses controls on the interface to enter the ingredient name, enter the price of the ingredient per applicable unit (in the example, units of weight), enter the heat sensitivity of the ingredient, enter the safety of the ingredient, how well cooked the ingredient must be, and the vitamin and mineral content of the ingredient by the applicable unit. This allows ingredients known to be unsafe to be flagged, and an ingredient that is suspected to be dangerous but not yet proven to be dangerous can be flagged as possibly dangerous. For example, legume peas are used in many commercial dog foods, however, a growing body of evidence supports the notion that such ingredient is possibly dangerous to dogs. In blocks 652-654, the user enters an optional note and saves the information entered in blocks 638-652.

FIG. 6F is a diagram illustrating exemplary operations associated with selecting the activity level of an animal in the animal database 128. In block 656, the user uses a control to select the activity level of the animal. In the illustrated embodiment, this is selected as a low, average, or high activity level as shown in blocks 658, 664, and 670, respectively. If a low activity level was selected, the user selects the species, and is presented with a dietary recommendation for the animal in terms of bodyweight per day, as shown in blocks 658-652. Similar entries are made for average or high levels of activity, as shown in blocks 664-674.

FIG. 6G is a diagram illustrating exemplary operations associated with entering deviations ranges for the nutrients. In block 676, the nutrient name is selected or entered. Maximum and minimum allowable deviations for nutrients from the daily recommended amount of nutrients are known, and are typically expressed as a per kilogram of body weight basis. In blocks 678-682, if the maximum value for the nutrient is too low, a control is presented to allow the user to edit the minimum by inputting a new value for the minimum. In blocks 674-688, if the minimum value for the nutrient is too high, a control is presented to allow the user to edit the minimum by inputting a new value for the minimum. In block 690, the information entered in blocks 678-688 is saved.

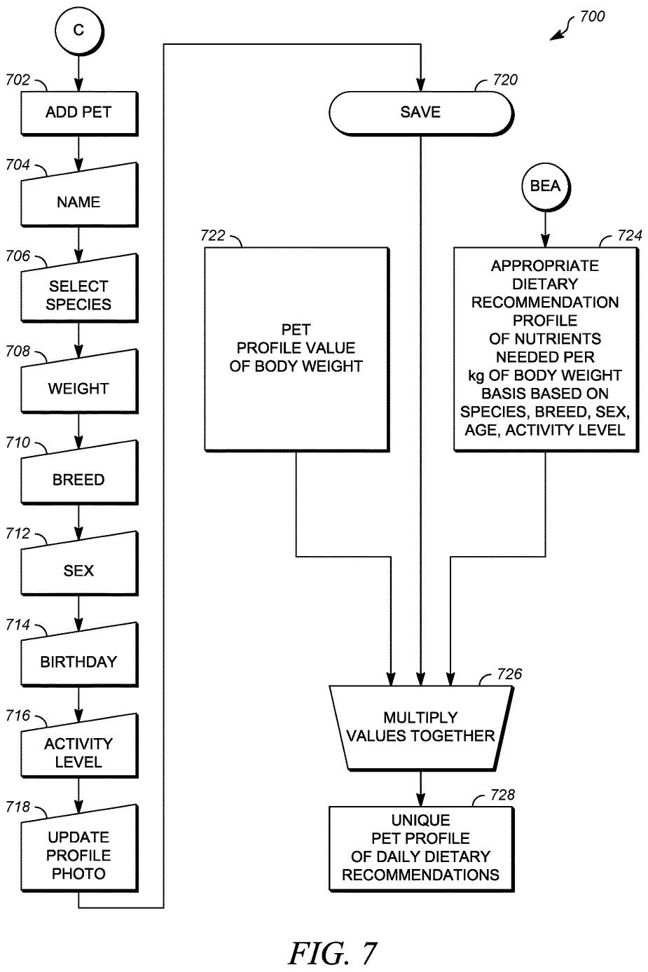

FIG. 7 is a diagram illustrating exemplary operations associated with adding an animal profile having animal data into the animal database 128. The process begins by the user selecting a presented control to add the pet to the database 128. The user is then prompted to enter pet information and the user enters that information as disclosed in blocks 704-718. This includes, for example, the pet's name, species, weight, breed, sex, birthday, activity level, and a profile photo. In block 720, the user selects a control to save the information entered in blocks 714-718.

Blocks 722-728 illustrate how the daily dietary recommendations for the pet are computed. The information in the pet profile and a database of dietary recommendations (in terms of animal weight) are multiplied to generate a pet profile of daily dietary requirements for the individual pet.

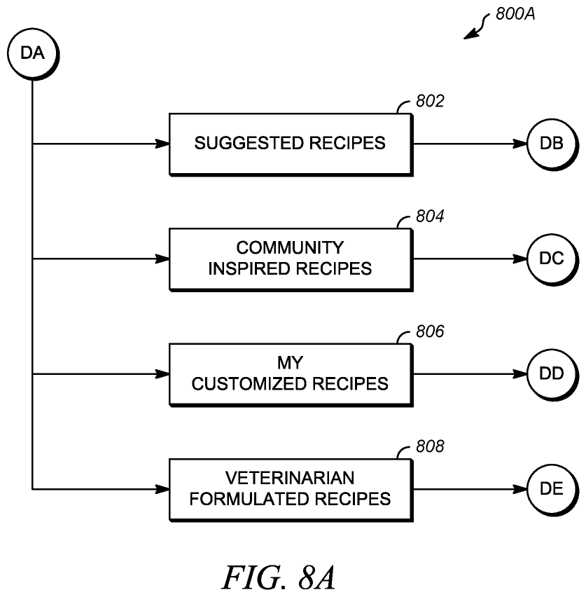

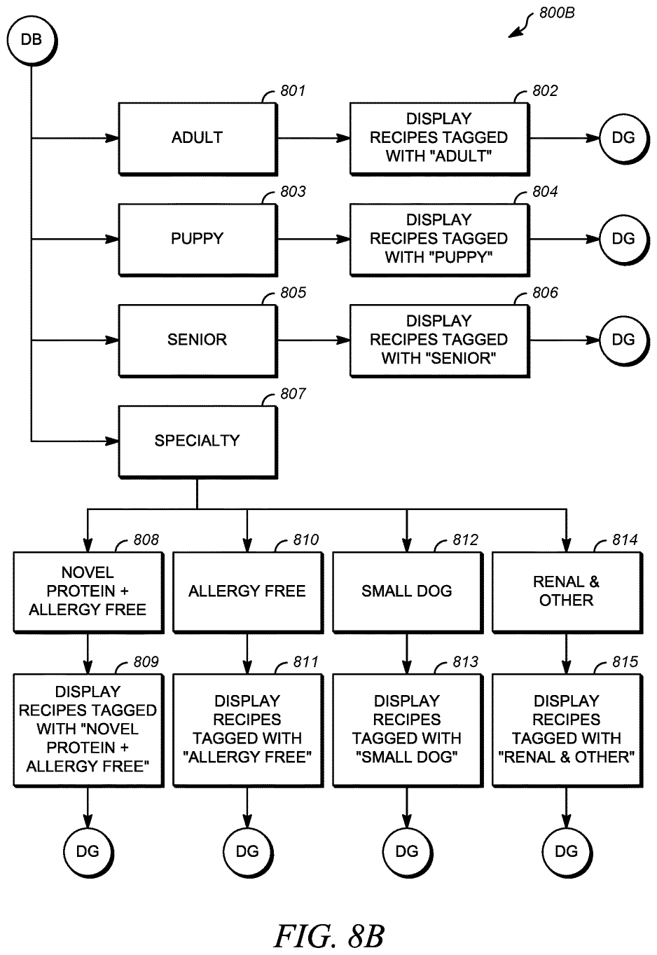

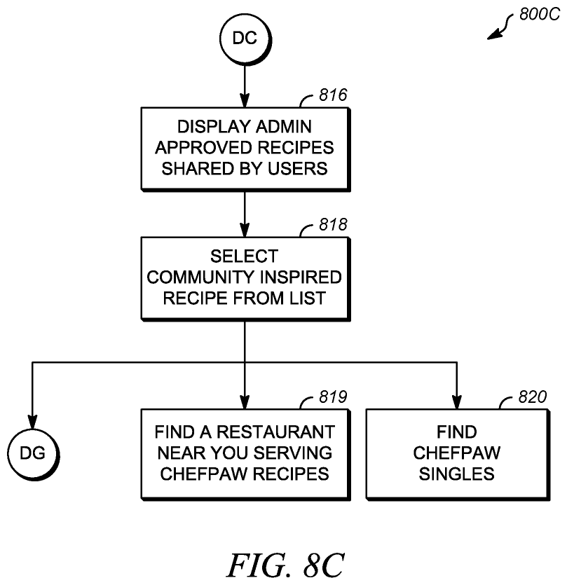

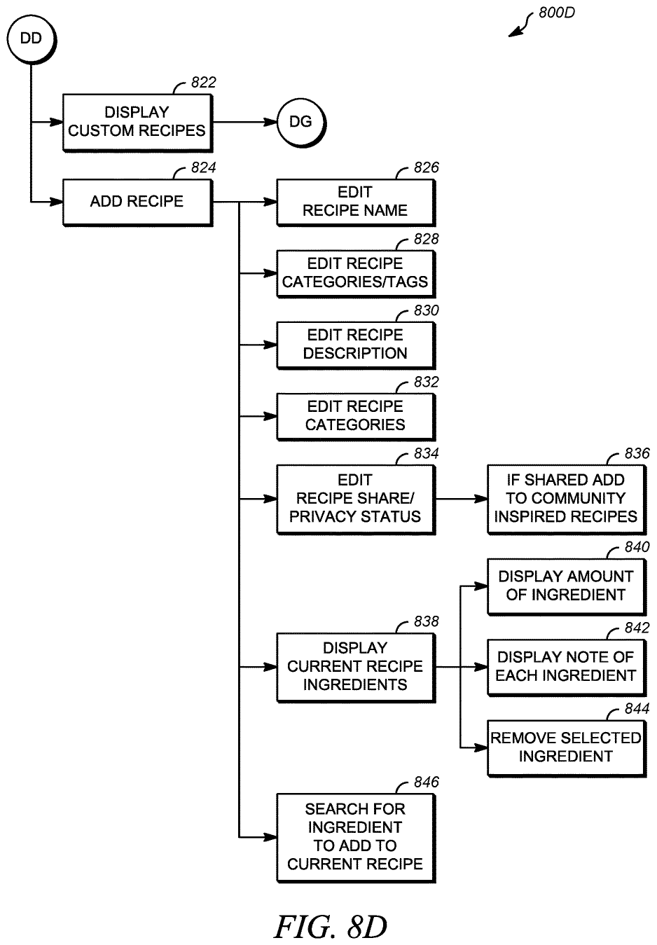

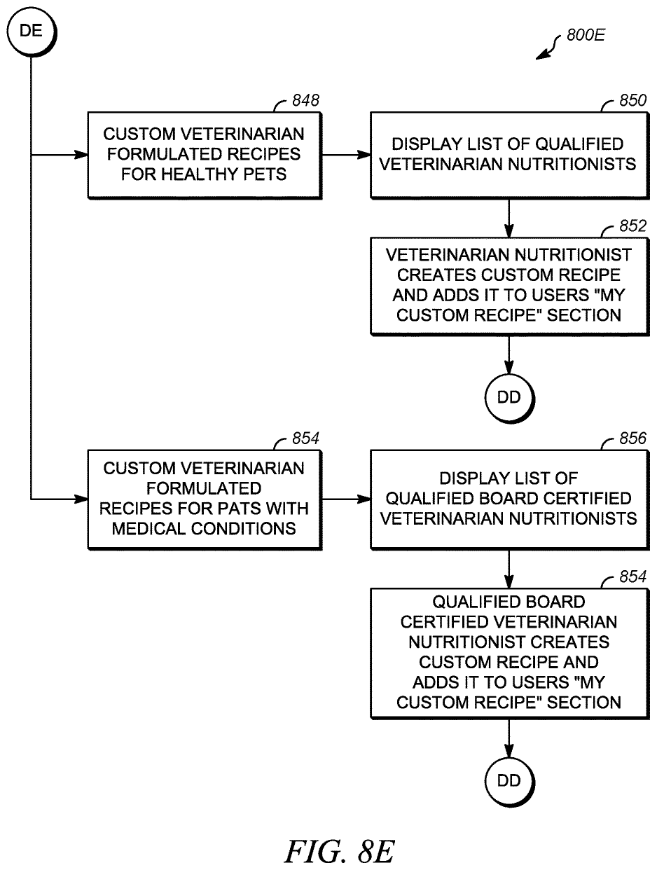

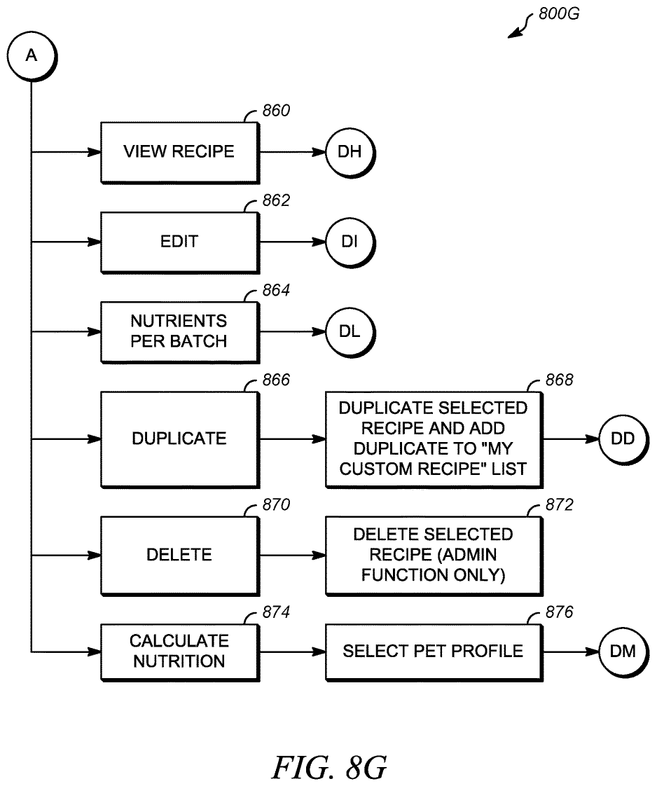

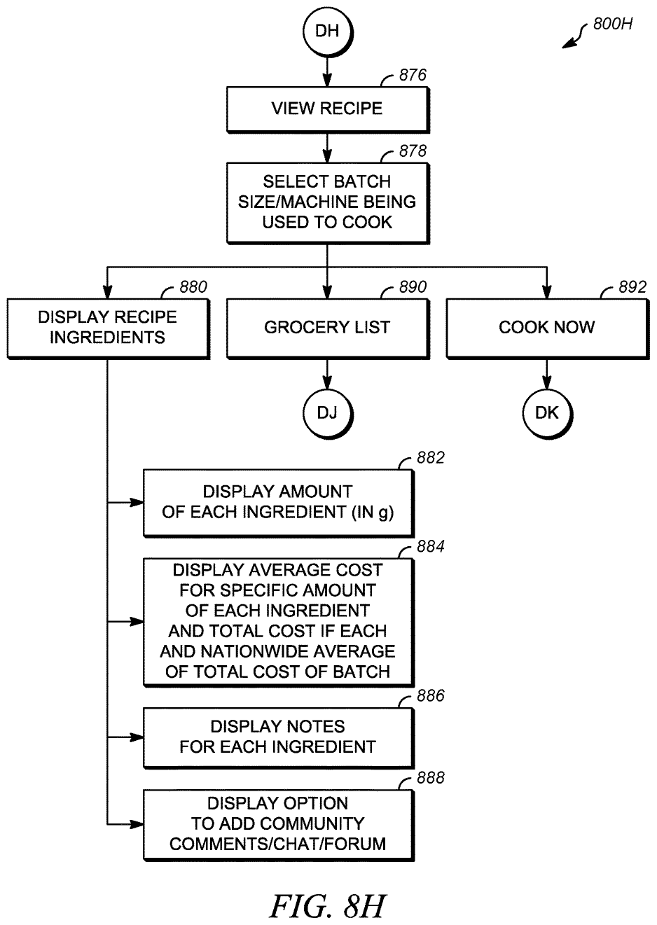

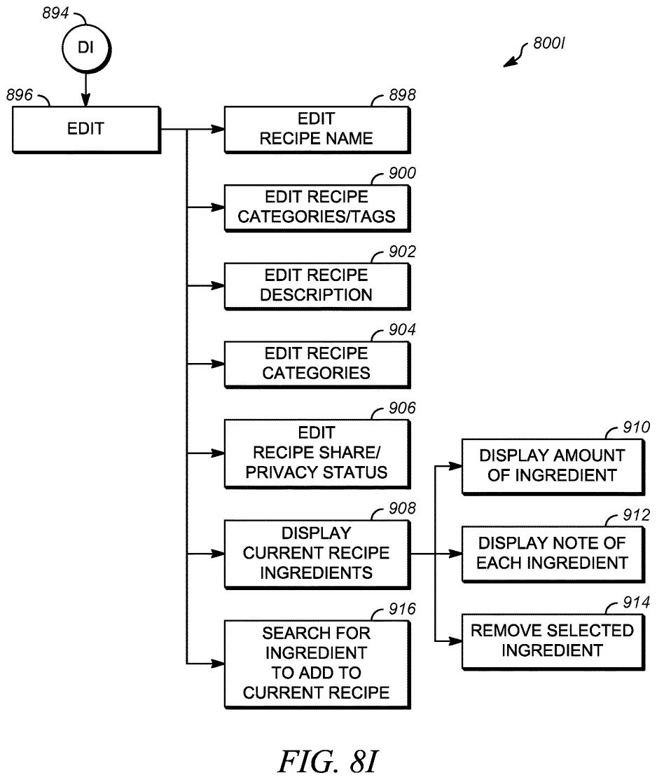

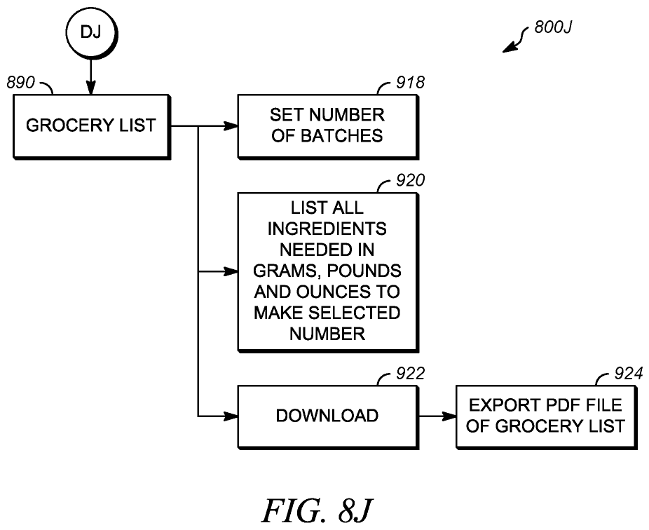

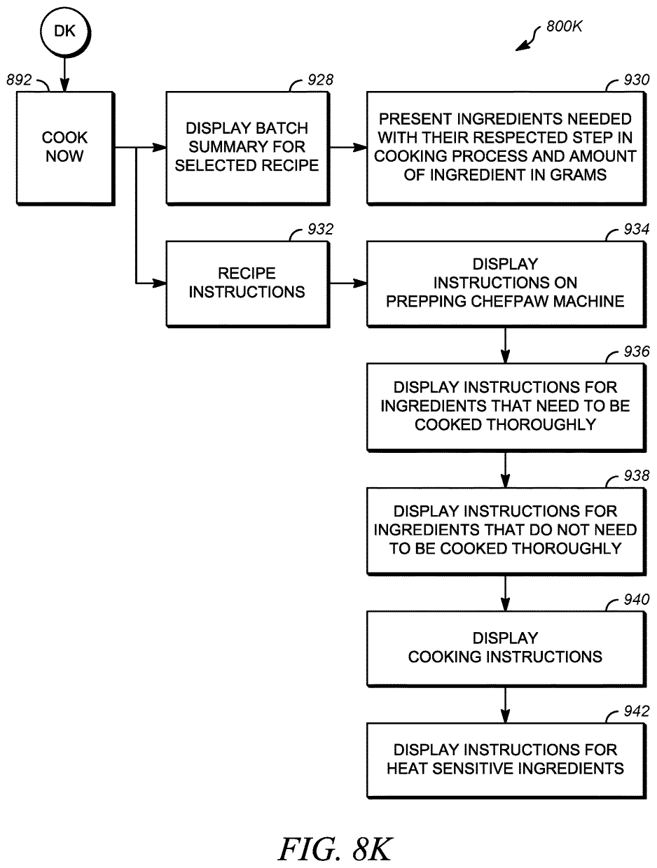

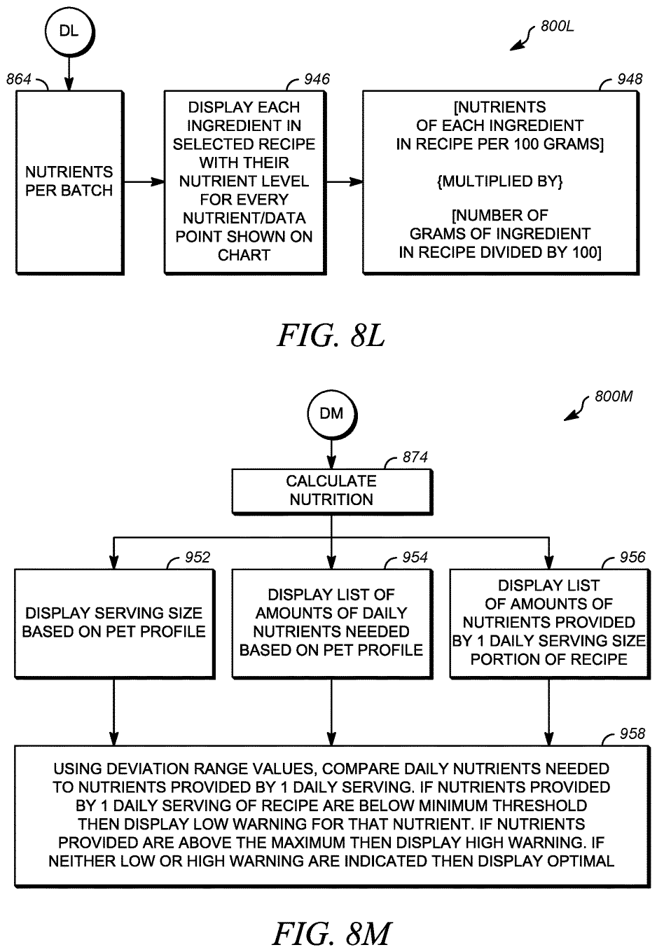

FIG. 8A is a diagram illustrating an exemplary embodiment of operations for managing recipes. blocks 802, 804, 806, and 808 refer to the selection of controls on the user interface to manage suggested recipes, community inspired recipes, customized recipes, and veterinarian formulated recipes, respectively.

FIG. 8B is a diagram illustrating an exemplary embodiment of operations for managing suggested recipes. The user is presented with controls allowing the user to research recipes for an adult animal, a young animal, a senior animal, and a special circumstances animal that has special dietary needs. This is illustrated in blocks 801, 803, 805, and 807, respectively. In the case of adult, young, and senior animals, recipes are retrieved from the recipe database 132 for animals of the selected age, and displayed, as shown in blocks 802, 804, and 806. If the user selected the specialty control 907, the user is presented with the option of selecting specialty diets for novel protein and allergy free recipes, allergy free recipes, small animal recipes, and recipes for animals with renal or other conditions, and recipes associated with those specialty conditions are presented in the user interface for selection as shown in blocks 808-815.

FIG. 8C is a diagram illustrating an exemplary embodiment of operations for accessing and managing recipes shared by others. In block 816, those shared recipes that have been approved by the administrator are displayed. In block 818, the user selects a shared recipe from the list. Based upon this selection the user may select an option to find a restaurant or other food source serving shared recipes or to find single recipes, as shown in blocks 819 and 820. Block 819 is a list of restaurants that have food processors 100 as described herein and sell animal food prepared by such food processors (thus allowing the pet to eat at the restaurant along with the owner of the pet. Block 820 includes, for example, a social media dating network of people who have a passion for homemade animal food. The user may also select an option to manage the shared recipes, as described further in FIG. 8F.

FIG. 8D is a diagram illustrating exemplary embodiments of operations for customized recipes. Block 823 illustrates displaying a control which can be selected by the user to display the custom recipes. Selection of the control displays the custom recipes to the user. Block 824 illustrates displaying a control to the user which can be selected to add a recipe. Selection of this control presents controls for performing the functions illustrated in blocks 826-846. Block 826 allows editing or creating the recipe name. Block 828 illustrates editing recipe categories or tags. Block 830 edits or enters the recipe description. Block 832 edits or creates recipe categories. Block 834 edits or creates the share/privacy status of the recipe. If the recipe is to be shared, the recipe is added to the group of community inspired recipes as shown in block 836. Block 838 illustrates selecting a control to display current recipe ingredients, and routes processing to blocks 840-844, which are options to display the amount of a selected one of the recipe of ingredients, display a note regarding each ingredient, or remove a selected ingredient. Block 846 permits the user to search for ingredients to add to the current recipe.

FIG. 8E is a diagram illustrating how veterinarian formulated recipes may be implemented by the food processor 100. The user is given an option to create custom veterinarian recipes for either healthy animals or animals with medical conditions, as shown in blocks 848 and 854. If block 848 is selected, a list of qualified veterinarian nutritionists is displayed, the veterinarian nutritionist selected is empowered to create a custom recipe and add it to the user's current recipes, as shown in blocks 850 and 852. This may be implemented by giving the veterinarian nutritionist access to the application and/or databases running on the recipe processor 104, or simply importing such recipes. If block 854, similar operations are performed for pets with medical conditions, as shown in blocks 856 and 858.

FIG. 8G is a diagram illustrating exemplary embodiments of operations to manage shared recipes. These include options to view the shared recipe, edit the shared recipe, view nutrients obtained from a batch of the recipe, duplicate a recipe, delete a recipe, or calculate the nutrition for a recipe, as shown in blocks 860-964, respectively. If a duplicate recipe control 866 is selected, the selected recipe is duplicated and added to a list of customized recipes, as shown in block 868. If “delete recipe” is selected, the administrator can delete the selected recipe, as shown in block 870 and 872. If the calculated nutrition control is selected 874, the user is presented with a control to select the pet profile, as shown in block 876.

FIG. 8H is a diagram illustrating exemplary embodiments of operations to view and manage recipes. In blocks 876 and 878, the user can select a control to view the recipe and select a batch size and machine being used to cook the recipe. User selection of a “display recipe ingredients” control 880 allows the user to selectively display an amount of each ingredient (block 882), for example in units of grams, display an average cost for a specific amount of each ingredient and total cost of a batch and a nationwide or local average of the total cost for a batch of the recipe (884), display notes for each ingredient of the recipe (block 886), and display an option to add community comments with regard to the recipe (block 888). Block 890 and 892 initiate selection of a grocery list menu or a cook now control, respectively.

FIG. 8I is a diagram illustrating exemplary embodiments of operations to edit a recipe. This option is entered by selecting the edit recipe control as shown in block 896. By selecting the appropriate control, the user may edit the recipe name, edit the recipe tags, edit the recipe description, edit the recipe categories, or edit the recipe share/privacy status, as shown in blocks 898-906, respectively. The user may also display the ingredients of the current recipe, including the amount of the ingredient, any notes regarding each ingredient, as shown in blocks 908-912. The user may also remove a selected ingredient, as shown in block 992. Finally, the user may use a control to search for an ingredient from the ingredient database 130 to add the ingredient to the currently displayed recipe, as shown in block 916.

FIG. 8J is a diagram illustrating operations performed when the grocery list 890 is selected. The user may select the number of batches to be prepared, as shown in block 918. Then, given this selection, a list of all ingredients needed in suitable units is presented to the user upon selection of an appropriate control, as shown in block 920. Units may be in weight (grams, pounds, or ounces) or may be in other units that can be converted to weight. Finally, the user may select a control to download the grocery list, and a list that can be printed or transmitted is generated, as shown in blocks 922 and 924.

FIG. 8K is a diagram illustrating the operations performed when the cook now 892 option is selected. In block 928, a batch summary is displayed for the selected recipe. Then, in blocks 928 and 930, the food processor 100 presents ingredients (for example, in units of weight such as grams) needed for the recipe according to the list in their respective step order in the cooking process. When the user selects a control to present the recipe instructions as shown in block 932, the food processor displays instructions for prepping the recipe, as shown in block 934. This includes displaying instructions for preparing ingredients that need to be thoroughly cooked, for ingredients that do not need to be thoroughly cooked, as shown in blocks 936 and 938. The food processor then displays cooking instructions, and displaying instructions for heat sensitive ingredients, as shown in blocks 940 and 942.

FIG. 8L is a diagram illustrating the calculation of nutrients in a batch. In block 946, each ingredient in the recipe is displayed with the nutrient level. In block 948, the nutrients per patch is computed as the product of the nutrient of each ingredient in the recipe per unit of weight (e.g. 100 grams) and the weight of the ingredient.

FIG. 8M is a diagram illustrating the nutrition calculation 874. In block 952, the service size based on the pet profile is displayed. In block 954, a list of the amount of daily nutrients needed for the pet (based on the pet profile entered earlier) are displayed. In block 956, the food processor 100 displays a list of the amounts of nutrients provided by one daily serving sized portion of the recipe. Finally, using deviation range values entered as described above, block 958 compares daily nutrients needed to the daily nutrients provided by 1 daily serving of the recipe. If the result is below the minimum threshold, the food processor 100 displays a “low” warning for that nutrient. If the nutrients provided are above the maximum value entered above, a “high” warning is displayed.

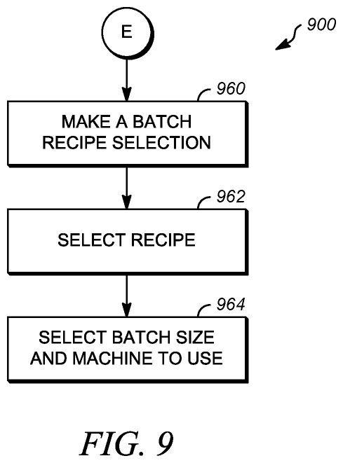

FIG. 9 is a diagram illustrating exemplary embodiments of operations to make a batch of food. In block 960, a control is selected to make a batch of a recipe. In block 962, the recipe is selected, and in block 964, the batch size and the food processor 100 to use (if the recipe processor 104 and ingredient processor 102 are not integrated) is selected. The user may then start preparing the food, with the food processor prompting the user to enter an indicated weight of each ingredient in order, with intervening processing steps such as mixing or cooking to be performed by the food processor 100. For example, the food processor 100 may display a message asking the user to insert 100 g of lean ground turkey meat into the vessel 162. The user may then start adding the ingredient, with the food processor weighing the ingredient with an integral scale (or the ingredient may be separately weighed). Once the proper amount of the ingredient is added, the food processor 100 may prompt for another ingredient or may instruct the user to start processing, at which time, the food processor 100 may activate the motor to turn the blades 164 to further chop up the ground turkey while activating a heating element to cook the ground turkey. After this process is completed, the food processor 100 would then prompt the user to add another ingredient, for example, a medium sized egg (which need not be weighed) or celery (which can be weighed). If the next ingredient in the recipe must be weighed, the food processor may prompt the user to enter the ingredient until the weight differential is such that the proper amount of the next ingredient has been weighed. This process may be completed until the entire batch of the recipe is prepared.

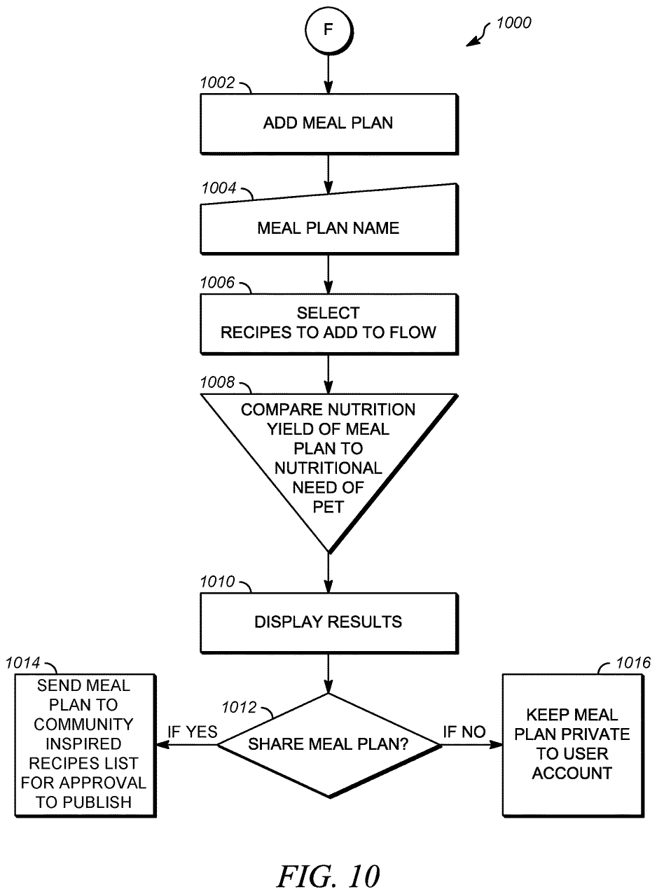

FIG. 10 is a diagram illustrating exemplary embodiments of operations to add a meal plan. As indicated, this process is initiated by selecting an “add a meal plan” control as shown in block 1002. The user may then enter a meal plan name 1004 and select recipes to add to the flow of meals that the animal will be eating, as shown in blocks 1004 and 1006. In blocks 1008 and 1010, the nutritional yield of the meal is compared to the nutritional yield of the meal plan to the nutritional needs of the animal. Block 1012 determines whether the user wants to share the meal plan. If so, the meal plan is sent to the set of community inspired recipes for publishing approval.

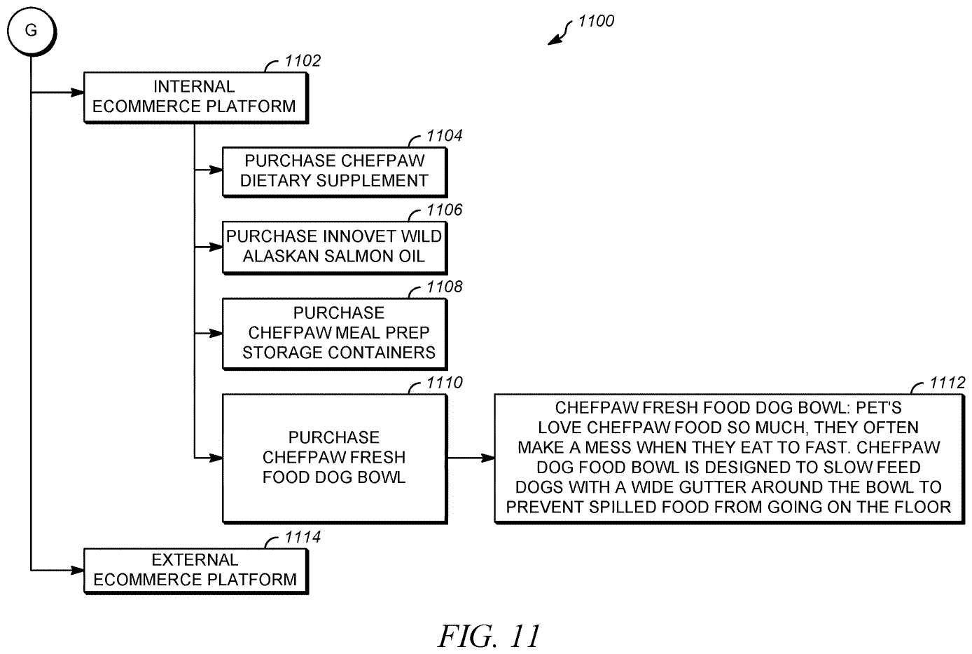

FIG. 11 is a diagram illustrating exemplary operations related to accessing an ecommerce platform. The ecommerce platform can be entered by selecting one of two controls 1102 and 1118 presented in the main menu. When control 1102 is selected, the user is presented with options including an option to purchase a sponsored dietary supplement, to purchase a related dietary supplement, to purchase meal preparation and storage containers, as shown in blocks 1104-1112. For example, storage containers can be offered that are shaped wider than their height and maximize cooling, refrigerating, freezing and reheating evenly. When control 1118 is selected, the user is referred to an external ecommerce platform.

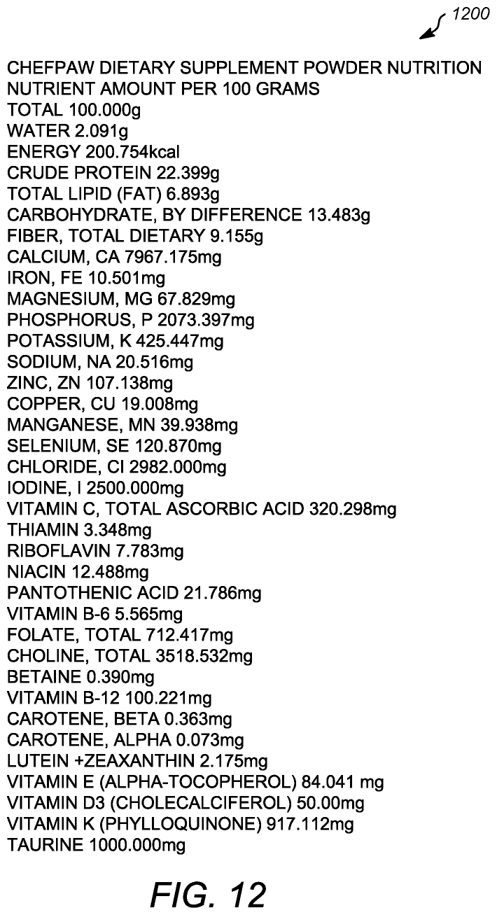

FIG. 12 is diagram of the nutritional profile of a dietary supplement for dogs.

This supplement provides nutritional improvement to the widest variety of fresh dog food recipes and requires the least amount of supplement needed per batch, thus minimizing the cost per batch.

### Processing Environment

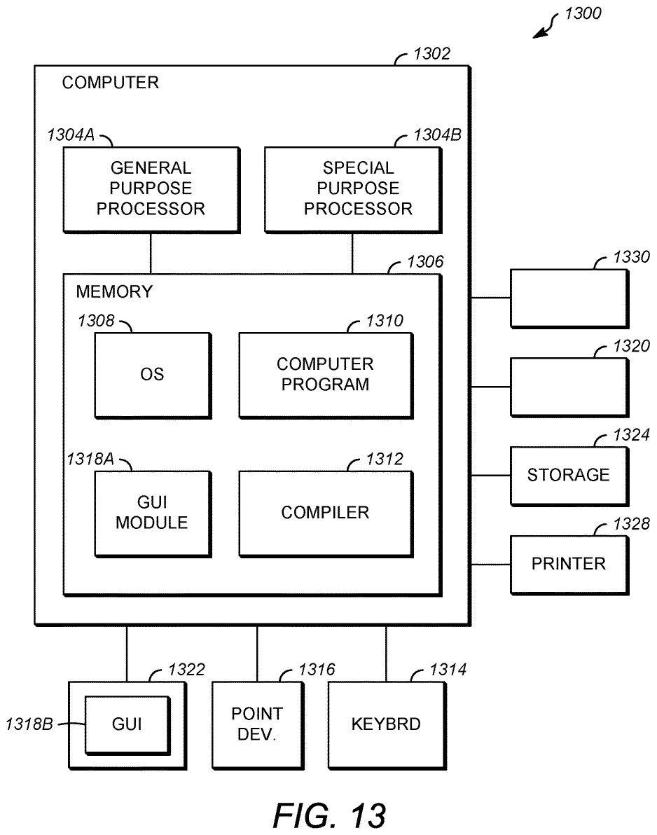

FIG. 13 illustrates an exemplary computer system 1300 that could be used to implement processing elements of the above disclosure, including the any of the processors computing the processing threads. The computer 1302 comprises a processor 1304 and a memory, such as random access memory (RAM) 1306. The computer 1302 is operatively coupled to a display 1322, which presents images such as windows to the user on a graphical user interface 1318B. The computer 1302 may be coupled to other devices, such as a keyboard 1314, a mouse device 1316, a printer 1328, etc. Of course, those skilled in the art will recognize that any combination of the above components, or any number of different components, peripherals, and other devices, may be used with the computer 1302.

Generally, the computer 1302 operates under control of an operating system 1308 stored in the memory 1306, and interfaces with the user to accept inputs and commands and to present results through a graphical user interface (GUI) module 1318A. Although the GUI module 1318B is depicted as a separate module, the instructions performing the GUI functions can be resident or distributed in the operating system 1308, the computer program 1310, or implemented with special purpose memory and processors. The computer 1302 also implements a compiler 1312 which allows an application program 1310 written in a programming language such as COBOL, C++, FORTRAN, or other languages to be translated into processor 1304 readable code. After completion, the application 1310 accesses and manipulates data stored in the memory 1306 of the computer 1302 using the relationships and logic that was generated using the compiler 1312. The computer 1302 also optionally comprises an external communication device such as a modem, satellite link, Ethernet card, or other device for communicating with other computers.

In one embodiment, instructions implementing the operating system 1308, the computer program 1310, and the compiler 1312 are tangibly embodied in a computer-readable medium, e.g., data storage device 1320, which could include one or more fixed or removable data storage devices, such as a zip drive, floppy disc drive 1324, hard drive, CD-ROM drive, tape drive, etc. Further, the operating system 1308 and the computer program 1310 are comprised of instructions which, when read and executed by the computer 1302, causes the computer 1302 to perform the operations herein described. Computer program 1310 and/or operating instructions may also be tangibly embodied in memory 1306 and/or data communications devices 1330, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

1. An apparatus for preparing at least one batch of animal food, comprising:
an ingredient processor, comprising:
a vessel for holding a plurality of ingredients;
blades disposed in the vessel, the blades coupled to a motor for rotating the blades;
a heater, thermally coupled to the vessel for heating the ingredients to cook the ingredients within the vessel;
a recipe processor, communicatively coupled to the ingredient processor, the recipe processor having a digital processor communicatively coupled to a memory storing digital processor instructions comprising digital processing instructions for:
generating or retrieving a recipe using at least a subset of the ingredients;
generating ingredient processor commands to prepare the animal food according to the recipe, the ingredient processor commands comprising:
heater commands, for commanding the heater to heat one or more of the ingredients according to the recipe;
motor commands, for blending one or more of the ingredients according to the recipe;
wherein the recipe processor is communicatively coupled to:
an ingredient database storing nutritional information regarding each ingredient in the ingredient database;
a recipe database storing one or more recipes, each recipe comprising a combination of ingredients and a procedure to combine the ingredients; and
an animal database, storing information regarding at least one animal, the information determining nutritional requirements of the animal.

2. The apparatus of claim 1, wherein:
the recipe processor generates the recipe by:
accepting user identified ingredients and ingredient amounts;
computing recipe nutritional values from the nutritional values for the accepted ingredients and ingredient amounts; and
comparing the computed nutritional values to the nutritional requirements of the pet.

3. The apparatus of claim 1 wherein:
the recipe is generated at least in part according to the recipe database, the ingredient database, the pet database, and a batch size to meet the nutritional requirements of the at least one pet without a nutritional supplement.

4. The apparatus of claim 3, wherein:
the recipe processor comprises a portable communication device having a data processor communicatively coupled to a memory storing a recipe processing application for:
generating or retrieving a recipe using at least a subset of the ingredients;
generating ingredient processor commands to prepare the animal food according to the recipe.

5. The apparatus of claim 4, wherein:
the ingredient database also stores unit cost of each ingredient; and
the recipe processor further computes the cost of the recipe according to the combined ingredients and the unit cost of each ingredient.

6. The apparatus of claim 1, further comprising:
a user interface, communicatively coupled to the recipe processor, comprising a user input interface for accepting user commands and a display interface for displaying information.

7. The apparatus of claim 1, wherein:
the recipe processor generates the recipe by:
accepting user identified ingredients and ingredient amounts;
computing recipe nutritional values from the nutritional values for the accepted ingredients and ingredient amounts; and
comparing the computed nutritional values to the nutritional requirements of the pet.

8. The apparatus of claim 1, wherein:
the heater commands include temperature and heater duration; and
the motor commands include blade speed and blade speed duration.

9. The apparatus of claim 1, wherein the vessel comprises a cooler for cooling the plurality of ingredients, the cooler comprising at least one of:
thermoelectric plates on or within a wall of the vessel, the thermoelectric plates controlled by the recipe processor according to cooling digital processor instructions to cool the plurality of ingredients; and
a cavity within the wall of the vessel, for cooling the ingredients via a circulation of a liquid though the cavity.

10. The apparatus of claim 1, wherein:
each of the blades have a first blade edge having a first sharpness and a second blade edge having a second sharpness less than the first sharpness; and
the recipe processor executes the digital processing instructions to control the motor to selectably rotate the blades in a clockwise or counterclockwise direction to control the texture of the prepared animal food.

11. The apparatus of claim 1, wherein:
the heater comprises about one square centimeter of heating surface are per 10 grams or 10 cubic centimeter of batch size;
the heater uses about 5 watts of heating energy per 1 cubic centimeter of heating surface area;
the motor rotates the blades at 30-150 revolutions per minute.

12. The apparatus of claim 11, wherein the vessel comprises a lid that retains at least 90% of water content of the ingredients during cooking.

13. A method of preparing animal food in a food processor comprising an ingredient processor having a vessel for holding a plurality of ingredients, blades disposed within the vessel coupled to a motor for rotating the blades, the method comprising:
(a) accepting, in a recipe processor communicatively coupled to the ingredient processor, pet information, the pet information determining nutritional requirements of the pet;
(b) accepting, in the recipe processor, one or more user-identified ingredients selected from an ingredient database, the ingredient database storing nutritional information regarding each ingredient in the ingredient database;
(c) computing, in the recipe processor, a recipe nutritional value from nutritional information of the selected ingredient;
(d) comparing the computed recipe nutritional value to the determined nutritional requirements of the pet to determine if the recipe nutritional value meets the determined nutritional requirements of the pet;
(e) if the recipe nutritional value does not meet the nutritional requirements of the pet, repeating steps (b)-(d) removing user-identified ingredients or accepting further user-identified ingredients selected from the ingredient database, recomputing the recipe nutritional value from the nutritional information of the further user-identified ingredients, and comparing the computed recipe nutritional value to the determined nutritional requirements of the pet.
(f) if the recipe nutritional value meets the nutritional requirements of the pet, transmitting, from the recipe processor to the ingredient processor, processing commands to prepare the animal food according to the recipe.

14. The method of claim 13, wherein:
(b) accepting, in the recipe processor, a user-identified ingredient selected from an ingredient database, the ingredient database storing nutritional information regarding each ingredient in the ingredient database further comprises:
accepting, in the recipe processor, an amount of the user-identified ingredient; and
the recipe nutritional value is computed from the nutritional information and the amount of the selected ingredient.

15. The method of claim 12, wherein:
the recipe nutritional value is computed according to a database of ingredients; and
the nutritional requirements is computed according to the pet information and a nutritional standard (AAFCO or NRC).

16. A method of preparing animal food in a food processor comprising an ingredient processor having a vessel for holding a plurality of ingredients, blades disposed within the vessel coupled to a motor for rotating the blades, and a heater for heating the plurality of ingredients, the method comprising:
(a) accepting, in a recipe processor communicatively coupled to the ingredient processor, pet information, the pet information determining nutritional requirements of the pet;
(b) accepting, in the recipe processor, a selection of a dish and a batch size;
(c) determining, in the recipe processor, the recipe from the pet information, the dish, and the batch size, the recipe comprising a plurality of ingredients, each of the plurality of ingredients associated with an ingredient amount, and an ordered set of food processor instructions for preparing the animal food dish; and
(d) accepting ingredients in the ingredient processor and automatically processing the ingredients according to the recipe.

17. The method of claim 16, further comprising:
automatically generating a shopping list of the plurality of ingredients and amounts.

18. The method of claim 17, further comprising:
automatically transmitting the shopping list to an ingredient supplier.

19. The method of claim 17, wherein
the method further comprises:
accepting, in the recipe processor, a selection of a second dish and a second batch size; and
computing, in the recipe processor, a second recipe from the second dish, the second batch size, and the pet information, the second recipe comprising a plurality of second ingredients, each of the plurality of second ingredients associated with a second ingredient amount, and a second ordered set of food processor instructions for preparing the second animal food dish;
wherein the shopping list is generated automatically according to the recipe and the second recipe.

20. The method of claim 16, further comprising:
(c1) presenting a list of the plurality of ingredients and associated ingredient amounts;
(c2) accepting a selection of a substitute ingredient and a substitute ingredient amount for at least one of the plurality of ingredients and associated ingredient amounts;
(c3) computing the recipe nutritional value for the recipe having the substitute ingredient and associated ingredient amount;
(c4) comparing the computed recipe nutritional value to the nutritional requirements of the pet to determine if the recipe nutritional value meets the determined nutritional requirements of the pet;
(c5) if the recipe nutritional value does not meet the nutritional requirements of the pet, repeating steps (c1)-(c4), recomputing the recipe nutritional value from the nutritional information of having the substitute ingredient and associated ingredient amount, and comparing the computed recipe nutritional value to the determined nutritional requirements of the pet.
